(19) United States
(12) Patent Application Publication
(10) Pub. No.: US 2024/0257559 A1
(43) Pub. Date: Aug. 1, 2024

(54) BIOMETRIC IMAGE LIVENESS DETECTION

(71) Applicant: Secure Identity, LLC, New York, NY (US)

(72) Inventor: Pieter Van Iperen, New York, NY (US)

(21) Appl. No.: 18/417,834

(22) Filed: Jan. 19, 2024

Related U.S. Application Data
(60) Provisional application No. 63/441,230, filed on Jan. 26, 2023.

(51) Int. Cl. G06V 40/40; G06T 1/00; G06T 7/90

(52) U.S. Cl. CPC G06V 40/40; G06T 1/0021; G06T 7/90; G06T 2207/10024; G06V 2201/07

(57) ABSTRACT

A system performs biometric liveness detection. A series of time generated codes are tracked by one or more servers. One or more user devices overlay a watermark on a captured image of a biometric according to one or more of the time generated codes. For example, the biometric may correspond to a face of a person. The one or more servers may detect whether or not the biometric is live by determining whether or not a provided image includes a watermark corresponding to the time generated code for the respective time that the provided image is provided.

### CROSS-REFERENCE TO RELATED APPLICATION(S)

This application is a nonprovisional patent application of and claims the benefit of U.S. Provisional Patent Application No. 63/441,230, filed Jan. 26, 2023 and titled “Biometric Image Liveness Detection,” the disclosure of which is hereby incorporated herein by reference in its entirety.

### FIELD

The described embodiments relate generally to liveness detection. More particularly, the present embodiments relate to biometric image liveness detection.

### BACKGROUND

Biometrics are physical or behavioral characteristics that may be associated with the identities of people. These may include fingerprints, blood vessel scans, palm-vein scans, voiceprints, facial images, retina images, iris images, deoxyribonucleic acid sequences, heart rhythms, gaits, and so on. Biometrics may be used to verify the identity of a person by comparing a digital representation of a biometric captured from the person (such as by using an image sensor to capture an image of the biometric) with stored biometric data associated with the identity of whom the person asserts himself to be. Biometrics may also be used to identify a person by comparing a digital representation of a biometric captured from the person (such as by using an image sensor to capture an image of the biometric) with stored biometric data associated with the identities of multiple people and ascertaining the identity associated with the stored biometric data that is determined to be a likely match.

In some situations, capture of biometrics is monitored by a live agent. The live agent may provide assistance, but may also ensure that there is no fraud during the capture of the biometric. In other situations, biometric capture may be performed in the context of various distributed computing arrangements. In such a situation, live agents may not monitor the biometric capture as people may provide digital representations of biometrics via one or more electronic devices that communicate over one or more wired and/or wireless networks with one or more other electronic devices that may perform biometric identity verification, biometric identification, and/or other operations using the digital representations of biometrics.

### SUMMARY

The present disclosure relates to biometric liveness detection. A series of time generated codes may be tracked by one or more servers. For example, the biometric may correspond to a face of a person. One or more user devices may overlay a watermark on a captured image of a biometric according to one or more of the time generated codes. The one or more servers may detect whether or not the biometric is live by determining whether or not a provided image includes a watermark corresponding to the time generated code for the respective time that the provided image is provided.

In various embodiments, a system for biometric image liveness detection includes a server and a user device that includes an image sensor. The server generates a series of time generated codes and records the series of time generated codes and time windows associated with the series of time generated codes. The user device receives the series of time generated codes; captures a first image of a biometric using the image sensor, the first image overlaid via filter with a watermark corresponding to one of the series of time generated codes whose associated time window corresponds to a current time; captures a second image of the biometric using the image sensor within a time period of the first image; and provides the first image and the second image to the server. The server determines that the first image and the second image were live captured upon determining that the watermark corresponds to the associated time window.

In some examples, the series of time generated codes specify a position of at least part of the watermark in the first image, a color of the at least part of the watermark in the first image, or a transparency of the at least part of the watermark in the first image. In a number of implementations of such examples, at least one of the position, the color, a number of dots, or the transparency changes between time generated codes of the series of time generated codes. In various implementations of such examples, the position is specified as a pixel position. In some implementations of such examples, the color is specified as an RGB color code.

In a number of examples, the time windows are between 2 seconds and 10 minutes. In various examples, the time period is less than 100 microseconds.

In some embodiments, a user device includes an image sensor, a non-transitory storage medium that stores instructions, and a processor. The processor executes the instructions to receive a series of time generated codes from a server, the series of time generated codes associated with time windows; capture a first image of a biometric using the image sensor, the first image overlaid via filter with a watermark corresponding to one of the series of time generated codes whose associated time window corresponds to a current time; capture a second image of the biometric using the image sensor within a time period of the first image; and provide the first image to the server.

In various examples, the series of time generated codes are unique to the user device and a user associated with the biometric. In some examples, the watermark includes a number of dots. In a number of implementations of such examples, the series of time generated codes specify a first number of dots in the watermark that are fully transparent and a second number of dots in the watermark that are partially transparent. In various implementations of such examples, at least one of the first number of dots or the second number of dots changes between time generated codes of the series of time generated codes.

In some examples, the series of time generated codes are received by an application implemented by the processor and the application isolates the series of time generated codes from other applications implemented by the processor. In various examples, the biometric includes an image of at least a face of a person.

In a number of embodiments, a server includes a non-transitory storage medium that stores instructions and a processor. The processor executes the instructions to generate a series of time generated codes; record the series of time generated codes and time windows associated with the series of time generated codes; provide the series of time generated codes to a user device that includes an image sensor; receive a first image of a biometric and a second image of the biometric from the user device, the first image captured by the user device using the image sensor, the first image overlaid via filter with a watermark corresponding to one of the series of time generated codes whose associated time window corresponds to a current time, the second image captured by the user device using the image sensor within a time period of the first image; and determine that the first image and the second image were live captured upon determining that the watermark corresponds to the associated time window.

In various examples, the processor verifies that the first image and the second image are unlikely to have been modified, tampered with, or physically faked prior to determining that the first image and the second image were live captured. In some implementations of such examples, the processor verifies that the first image and the second image are unlikely to have been modified, tampered with, or physically faked using machine learning pixel detection.

In a number of examples, the processor compares the biometric in the first image to the biometric in the second image prior to determining that the first image and the second image were live captured. In various examples, the processor uses the second image for biometric identification upon determining that the first image and the second image were live captured. In some examples, the processor uses the second image for biometric identification system enrollment upon determining that the first image and the second image were live captured.

### BRIEF DESCRIPTION OF THE DRAWINGS

The disclosure will be readily understood by the following detailed description in conjunction with the accompanying drawings, wherein like reference numerals designate like structural elements.

FIG. 1 depicts an example system for biometric image liveness detection.

FIG. 2 is a flow chart illustrating a first example method for biometric image liveness detection. The method may be performed by the system of FIG. 1.

FIG. 3 is a flow chart illustrating a second example method for biometric image liveness detection. The method may be performed by the system of FIG. 1.

FIG. 4 depicts a first image of a biometric.

FIG. 5 depicts a second image of a biometric including a watermark.

FIG. 6 depicts an example of a time generated code data structure.

FIG. 7 is a flow chart illustrating a third example method for biometric image liveness detection. The method may be performed by the system of FIG. 1.

FIG. 8 is a flow chart illustrating a fourth example method for biometric image liveness detection. The method may be performed by the system of FIG. 1.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, apparatuses, methods, and computer program products that embody various elements of the present disclosure. However, it should be understood that the described disclosure may be practiced in a variety of forms in addition to those described herein.

The inability to use live agents to prevent fraud during biometric capture in distributed computing arrangements is a technical problem introduced by implementing biometric capture in a distributed computing arrangement as the very fact that the biometric capture is moved to a distributed computing arrangement is why the traditional practice of using live agents to prevent fraud during biometric capture cannot be used to prevent the fraud. As such, it may be more difficult to protect against techniques like spoofing.

For example, biometric identity verification or identification application may instruct a person to take an image of the person's face. This image may be compared against stored biometric data using facial recognition. However, a person may take an image of a picture of another person's face (such as a photograph mounted on a stick, a photograph displayed on the screen of another device, and so on) instead of taking an image of the person's face in an attempt to fool the facial recognition. As such, it may be necessary to determine whether or not the provided image is “live” instead of being an image taken of a preexisting picture.

To combat such, passive solutions involving machine learning may be used to detect whether or not a provided image contains characteristics like the frame of a phone, features indicating that the provided image is flat instead of being in three-dimensions, and so on. However, these passive solutions may be useful for detecting that a person has taken an image of a preexisting picture, but may not be capable of detecting when the person digitally provides a preexisting picture instead of taking an image of a preexisting picture (such as digital photographs taken from a social media account of someone whose identity the person is attempting to spoof). After all, such a preexisting picture may have been taken live and would thus not contain characteristics like the frame of a phone, features indicating that the provided image is flat instead of being in three-dimensions, and so on. Instead, the preexisting picture was simply not taken at the time asserted using the electronic device asserted.

Interactive solutions may be used to detect this latter situation, such as by verifying that the image has a current lighting, by triggering patterns of iris dilation and detecting such pattern in the image, instructing the person to change their position with respect to the image sensor in a particular way and then verifying that this is present in the image, and so on. However, such interactive solutions may be burdensome for the user, may also be spoofed, and may consume a great deal of time and/or other hardware and/or software resources.

These issues may be overcome using a series of time generated codes tracked by one or more servers. One or more user devices may overlay a watermark on a captured image of a biometric according to one or more of the time generated codes. The one or more servers may detect whether or not the biometric is live by determining whether or not a provided image includes a watermark corresponding to the time generated code for the respective time that the provided image is provided.

In this way, a technical solution is provided to the technical problem of how to perform biometric liveness detection without live agents that was introduced by implementing biometric capture and/or other biometric operations in various distributed computing arrangements. As a result of using these techniques, the problem of spoofing by digitally providing existing images may be prevented. Further, more burdensome interactive solutions may be reduced and/or eliminated, improving the user interface for users. Additionally, through the use of these techniques, consumption of time and/or other hardware and/or software resources by such interactive solutions may be reduced and/or eliminated, thus improving the operation of one or more electronic devices involved therein.

This may allow performance of functions that were previously not performable and enable more efficient operation while expending less work, eliminating unnecessary hardware and/or other components, and more efficiently using hardware, software, network, and/or other resources. This may improve the operation of systems involved by reducing unnecessary components, increasing the speed at which the systems perform operations, and/or reducing consumption of hardware, software, network, and/or other resources.

The present disclosure relates to biometric liveness detection. A series of time generated codes may be tracked by one or more servers. For example, the biometric may correspond to a face of a person. Alternatively, the biometric may correspond to one or more fingerprints, palms, blood vessels, palm-veins, retinas, irises, gaits, and so on. One or more user devices may overlay a watermark on a captured image of a biometric according to one or more of the time generated codes. The one or more servers may detect whether or not the biometric is live by determining whether or not a provided image includes a watermark corresponding to the time generated code for the respective time that the provided image is provided.

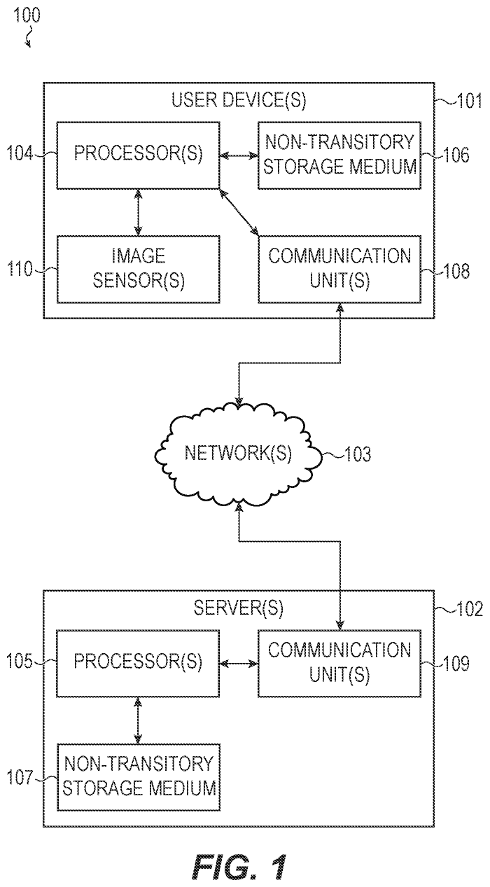

These and other embodiments are discussed below with reference to FIGS. 1-8. However, those skilled in the art will readily appreciate that the detailed description given herein with respect to these Figures is for explanatory purposes only and should not be construed as limiting.

FIG. 1 depicts an example system 100 for biometric image liveness detection. A series of time generated codes may be tracked by one or more servers 102. For example, the biometric may correspond to a face of a person. Alternatively, the biometric may correspond to one or more fingerprints, palms, blood vessels, palm-veins, retinas, irises, gaits, and so on. One or more user devices 101 may overlay a watermark on a captured image of a biometric according to one or more of the time generated codes. The time generated codes may be time generated because they may be generated for particular time windows. The server 102 may detect whether or not the biometric is live by determining whether or not a provided image includes a watermark corresponding to the time generated code for the respective time that the provided image is provided.

The server 102 may generate and store the time generated codes associated with times when the time generated codes may be used. For example, the server 102 may generate new time generated codes every 2 seconds, 10 minutes, and so on. The server 102 may provide the time generated codes to the user device 101, provide watermarks generated from the time generated codes to the user device 101, and so on. The time generated codes may be specific to the user device 101 and the person who is asserting to be using the user device 101 such that every different person using a different user device 101 may be associated with different time generated codes.

In some examples, the server 102 may provide a current time generated code upon receiving a request from the user device 101. In other examples, the server 102 may provide a new time generated code each time that the new time generated code is generated.

The user device 101 may include one or more apps or applications (such as an app or application associated with a software development kit provided by an entity who controls the server 102) configured to securely communicate with the server 102 in order to receive one or more time generated codes and/or watermarks, overlay one or more watermarks over one or more images of one or more biometrics that the app or application captures with one or more image sensors 110, and provide the images to the server 102. In this way, control over the time generated codes and/or watermarks may be established so that only the app or application and the server has access. This may prevent interception of the time generated codes and/or watermarks by other devices so that the other devices cannot overlay the watermarks over preexisting images and transmit them to the server before the watermarks are no longer valid.

The time generated codes and/or watermarks received by the user device 101 may include information specifying the time that the time generated codes and/or watermarks are valid and the user device 101 may evaluate such information to determine which time generated code and/or watermark to use. Alternatively, such information may be omitted and the user device 101 may use the most recent one that was requested and/or received.

The time generated codes may include a variety of information regarding the watermarks, for example, a placement position of the watermark on the image of the biometric, one or more colors (such as one or more RGB color codes) of the watermark, a number of dots that make up the watermark, a number of dots that are full or partially transparent, and so on. The time generated codes may be in a sequence. The sequence of time generated codes may be time linked in storage of the server 102 (such as the non-transitory storage medium 107), may cause the watermarks to change on the images of the biometric over time, such as by changing position, changing color, changing the number of full or partially transparent dots, and so on as the time generated codes and/or the watermarks change. In other words, changing the time generated codes and/or the watermarks every 2 seconds, ten minutes, and so on may result in the changing position, changing color, changing the number of full or partially transparent dots, and so on of the watermarks on the images of the biometrics every 2 seconds, ten minutes, and so on. This may involve too many possible variants for an attacker to be able to spoof. The time generated codes may also be time bound and short-lived. In some examples, the watermark may correspond to a branded logo associated with the app or application executing on the user device 101.

For example, a time generated code may specify a position within 640×480, one of 255\hat{ }3 RGB codes, and one of 30\hat{ }2 dot transparencies. This results in approximately 4.6 quadrillion watermark variants. Previous security token standards only typically have around 10\hat{ }8 or 100 billion variants. Since the time generated codes are time bound, an attacker would have to find the correct variant in the time bound (such as 2 seconds, 10 minutes, and so on). This makes iteration through the variants nearly impossible with even distributed supercomputing power.

In some examples, the user device 101 may overlay the watermark on a portion of the captured image that does not interfere with use of the captured image for biometric identity verification, biometric identification, and/or other biometric operations. For example, images of faces may typically have the face positioned at the center and overlaying the watermark on one of the corners, such as the top left or right corner, and may leave the face unobscured so that the watermark does not interfere with the image of the face for biometric identity verification, biometric identification, and/or other biometric operations.

In various examples, the user device 101 may capture another image of the biometric within a short period of time (such as 5 microseconds apart) of the one with the watermark. The user device 101 may then provide both to the server 102. The server 102 may then provide the one with the watermark for biometric liveness detection and the other for biometric identity verification, biometric identification, and/or other biometric operations.

For example, in a number of implementations, a person may go to take an image of a biometric (such as the person's face) using an app or application executing on the user device 101. The app or application may communicate a request to the server 102 for one or more of a series of time generated codes. Each code may represent the top left placement position in a limited portion of the image (640×480), an RGB color code, and a number of dots to present in the watermark. As the person is positioning their face to take the image, the watermark may be overlaid via a filter. The watermark may move, change color, edit the number of full or partial transparency dots, and so on at intervals such as every 2 seconds, 10 minutes, and so on). The shifting watermark may be time linked in the storage of the server 102. Then the person takes the image, the image with the filter composite, and another image without the filter which may both be taken in succession, such as microseconds apart. Both images may then be sent to the server 102. The server 102 may compare the position, number of full dots, dot positions, and the RGB color of the watermark. The server 102 may determine that the image is taken live when all correspond to the time generated code on the server 102 for the time window when the image is sent. Further, the server 102 may verify that the biometrics (such as faces) in the two images (composite and non-composite images) correspond (such as determining that the images are both of the same face). One or more of the images may then be run through machine learning pixel detection to ensure that the image(s) are unlikely to have been modified in editing software and/or otherwise tampered with and/or physically faked (i.e., an image of a photograph on a stick). Once the 3 checks clear, the image without the watermark may be determined to be live and may be used. This may ensure that the image was taken at that specific time by the user device 101 using the image sensor 110. For example, the image without the watermark may be used to perform biometric identity verification, biometric identification, and/or other biometric operations.

Although a specific configuration is illustrated and described above, it is understood that this is an example. In other implementations, other configurations may be implemented. For example, the above illustrates and describes overlaying a watermark on an image. However, in other implementations, pixels of the image may instead be modified according to one or more time generated codes. This may make it more challenging to ensure that the image was not modified in editing software and/or otherwise tampered with, but may still be performed. Various configurations are possible and contemplated without departing from the scope of the present disclosure.

The server 102 may be connected to the user device 101 via one or more wired and/or wireless networks 103. The server 102 may store identity information (such as one or more names, addresses, telephone numbers, social security numbers, patient identification numbers or other identifiers, insurance data, financial data, health information (such as one or more temperatures, pupil dilation, medical diagnoses, immunocompromised conditions, medical histories, medical records, infection statuses, vaccinations, immunology data, results of antibody tests evidencing that a person has had a particular communicable illness and recovered, blood test results, saliva test results, and/or the like), and so on) associated with the identities of people (which may be verified identities, where the identities are verified as corresponding to the particular person named and/or where the identity information is verified as valid). Alternatively and/or additionally, some or all of the health information may be stored separately from the identity information but otherwise associated with the identity information, such as in a Health Insurance Portability and Accountability Act (“HIPAA”) compliant or other data store or enclave. Such a data store or enclave may be stored on one or more different storage media than the identity information, or may be stored on the same storage medium or media and logically isolated from the identity information. The health information may be simultaneously and/or substantially simultaneously accessible as the identity information, such as where the identity information includes a health information identifier or key that may be used to access the separately stored health information. The identity system device may control access to the identity information and/or the health information using identification information that is associated with the identity information. The identification information may include biometric data (which may include one or more digital representations of one or more fingerprints, blood vessel scans, palm-vein scans, voiceprints, facial images, retina images, iris images, deoxyribonucleic acid sequences, heart rhythms, gaits, and so on), one or more logins and/or passwords, authorization tokens, social media and/or other accounts, and so on. In various implementations, the identity system device may allow the person associated with an identity to control access to the identity information, the health information, and/or other information (such as payment account information, health information (such as medical records, HIPAA protected information in order to be compliant with various legal restrictions, and so on), contact information, and so on. The identity system device may control access to such information according to input received from the person. The identity system device may be operable to communicate with the modular biometric station in order to handle requests to provide the identity information and/or the health information, update and/or otherwise add to the identity information and/or the health information, provide attestations regarding and/or related to the identity information and/or the health information (such as whether or not a person is of a particular age, whether or not a person has a particular license or insurance policy, whether or not a person has been monitored as having particular health information, whether or not a person has had a particular vaccination, whether or not an antibody test evidences that a person has had a particular communicable illness and recovered, whether or not a person has a particular ticket or authorization, whether or not a person has been monitored as having particular antibodies, whether or not a person has been assigned a particular medical diagnosis, and so on), evaluate health information stored in the identity information and/or otherwise associated with the identity information and/or other information stored in the identity information, perform transactions, allow or deny access, route one or more persons, and/or perform one or more other actions.

The server 102 may be any kind of electronic device and/or cloud and/or other computing arrangement. Examples of such devices include, but are not limited to, one or more desktop computing devices, laptop computing devices, mobile computing devices, wearable devices, tablet computing devices, mobile telephones, kiosks and/or other stations, smart phones, printers, displays, vehicles, kitchen appliances, entertainment system devices, digital media players, and so on. The server 102 may include one or more processors 105 and/or other processing units or controllers, communication units 109 (such as one or more network adapters and/or other devices used by a device to communicate with one or more other devices), non-transitory storage media 107, and/or other components. The processor 105 may execute one or more sets of instructions stored in the non-transitory storage media 107 to perform various functions, such as receiving and/or storing biometric data and/or other identification information, receiving and/or storing identity information and/or health information, matching one or more received digital representations of biometrics and/or other identification information to stored data, retrieving identity information and/or health information associated with stored data matching one or more received digital representations of biometrics and/or other identification information, providing retrieved identity information and/or health information, communicating with the modular biometric station via the network 103 using the communication unit 109, and so on. Alternatively and/or additionally, the server 102 may involve one or more memory allocations configured to store at least one executable asset and one or more processor allocations configured to access the one or more memory allocations and execute the at least one executable asset to instantiate one or more processes and/or services, such as one or more gallery management services, biometric identifications services, and so on.

Similarly, the user device 101 may be any kind of device. The user device 101 may include one or more processors 104 and/or other processing units and/or controllers, one or more non-transitory storage media 106 (which may take the form of, but is not limited to, a magnetic storage medium; optical storage medium; magneto-optical storage medium; read only memory; random access memory; erasable programmable memory; flash memory; and so on), one or more communication units 108; one or more image sensors 110 (such as a still image and/or video camera, a 2D and/or 3D image sensor, and so on); one or more health sensors (such as a thermometer and/or other thermal sensor, a blood pressure sensor, a blood test sensor, a blood vessel scanner, a palm-vein scanner, a still image and/or video camera, a 2D and/or 3D image sensor, a saliva sensor, a breath sensor, a deoxyribonucleic acid sensor, a heart rhythm monitor, a microphone, sweat sensors, and so on); one or more biometric readers (such as a fingerprint scanner, a blood vessel scanner, a palm-vein scanner, an optical fingerprint scanner, a phosphorescent fingerprint scanner, a still image and/or video camera, a 2D and/or 3D image sensor, a capacitive sensor, a saliva sensor, a deoxyribonucleic acid sensor, a heart rhythm monitor, a microphone, and so on), and/or one or more other components. The processor 104 may execute one or more sets of instructions stored in the non-transitory storage media 106 to perform various functions, such as using the biometric reader to obtain one or more digital representations of one or more biometrics (such as a digital representation of a fingerprint, a blood vessel scan, a palm-vein scan, a voiceprint, a facial image, a retina image, an iris image, a deoxyribonucleic acid sequence, a heart rhythm, a gait, and so on) for a person, obtain health information for a person using the health sensor, communicate with the identity system device via the network 103 using the communication unit 108, and so on.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices and systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., driver's licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

Although a specific arrangement of components is illustrated and described above, it is understood that this is an example. In other implementations, other arrangements of the same, similar, and/or different components may be used. For example, the above illustrates and describes one or more servers 102. However, in other implementations, a cloud computing arrangement may be used. Various configurations are possible and contemplated without departing from the scope of the present disclosure.

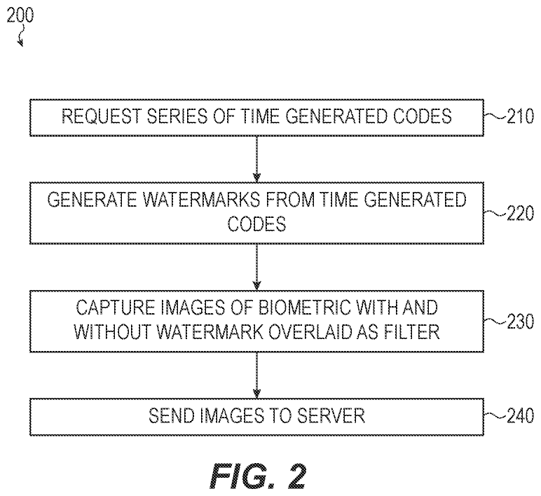

FIG. 2 is a flow chart illustrating a first example method 200 for biometric image liveness detection. The method 200 may be performed by the system 100 of FIG. 1.

At operation 210, an electronic device (such as the user device 101 of FIG. 1) may request a series of time generated codes. The series of time generated codes may be specific to the electronic device and/or a person who assets himself to be using the electronic device. The series of time generated codes may include information detailing characteristics for generating one or more watermarks.

At operation 220, the electronic device may generate one or more watermarks from one or more time generated codes from the series of time generated codes. The electronic device may generate the one or more watermarks according to information detailing characteristics for generating one or more watermarks included in the one or more time generated codes from the series of time generated codes.

At operation 230, the electronic device may capture images of a biometric with and without the watermark overlaid as filter. The electronic device may capture the images using one or more image sensors, such as one or more still image and/or video cameras.

At operation 240, the electronic device may send images to one or more servers. The server may be the server 102 of FIG. 1.

In various examples, this example method 200 may be implemented using a group of interrelated software modules or components that perform various functions discussed herein. These software modules or components may be executed within a cloud network and/or by one or more computing devices, such as the user device 101 of FIG. 1.

Although the example method 200 is illustrated and described as including particular operations performed in a particular order, it is understood that this is an example. In various implementations, various orders of the same, similar, and/or different operations may be performed without departing from the scope of the present disclosure.

For example, the method 200 is illustrated and described as the electronic device requesting the series of time generated codes. However, it is understood that this is an example. In some implementations, the electronic device may receive the series of time generated codes without requesting such. In other implementations, the electronic device may request a single time generated code from the series of time generated codes without requesting the series of time generated codes itself. Various configurations are possible and contemplated without departing from the scope of the present disclosure.

Further, in various implementations, the electronic device may request and/or receive the watermarks rather than generating such. Various configurations are possible and contemplated without departing from the scope of the present disclosure.

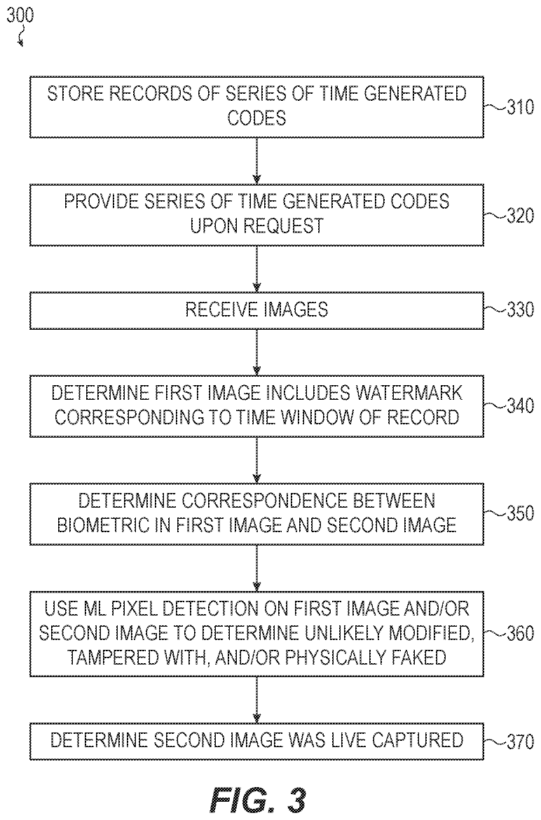

FIG. 3 is a flow chart illustrating a second example method 300 for biometric image liveness detection. The method 300 may be performed by the system 100 of FIG. 1.

At operation 310, an electronic device (such as the server 102 of FIG. 1) may store records of one or more series of time generated codes. The series of time generated codes may be specific to a user device and/or person asserting to be using the user device. The series of time generated codes may include information for generating one or more watermarks at one or more time windows.

At operation 320, the electronic device may provide the series of time generated codes upon request. For example, the electronic device may establish a secure communication connection with an app or application executing on the user device and may then provide one or more of the series of time generated codes upon request, such as a current time generated code.

At operation 330, the electronic device may receive a pair of images from the user device. The images may be images of a biometric. One of the images may include a watermark. The images may be taken closely in time, such as within a number of microseconds.

At operation 340, the electronic device may determine that a first image of the pair of images includes a watermark corresponding to a time window of record. The electronic device may determine this by determining that characteristics of the watermark (position, color, number of dots, transparency of dots, etc.) correspond to information specified in the time generated code associated with the records of the one or more series of time generated codes for the time window.

At operation 350, the electronic device may determine correspondence between the biometric in a first image and a second image. For example, the electronic device may determine that a biometric depicted in the first and second images match.

At operation 360, the electronic device may use ML (machine learning) pixel detection on the first image and/or the second image. The electronic device may do this to ensure that the first image and/or the second image is unlikely to have been modified in editing software and/or otherwise tampered with and/or physically faked (i.e., an image of a photograph on a stick).

At operation 370, the electronic device may determine the second image was live captured. The electronic device may determine this when operations 340, 350, and 360 are successful. If the electronic device determines that the second image is live captured, the electronic device may then use the second image to perform biometric identity verification, biometric identification, and/or other biometric operations.

In various examples, this example method 300 may be implemented using a group of interrelated software modules or components that perform various functions discussed herein. These software modules or components may be executed within a cloud network and/or by one or more computing devices, such as the server 102 of FIG. 1.

Although the example method 300 is illustrated and described as including particular operations performed in a particular order, it is understood that this is an example. In various implementations, various orders of the same, similar, and/or different operations may be performed without departing from the scope of the present disclosure.

For example, operation 320 illustrates and describes the electronic device providing the series of time generated codes upon request. However, it is understood that this is an example. In some implementations, one or more time generated codes are provided without being requested. Various configurations are possible and contemplated without departing from the scope of the present disclosure.

By way of another example, the method 300 illustrates and describes receiving a pair of images. However, it is understood that this is an example. In some implementations, a single image may be received. Various configurations are possible and contemplated without departing from the scope of the present disclosure.

In yet another example, operation 360 illustrates and describes use of ML pixel detection. However, it is understood that this is an example. In some implementations, such an operation may be omitted. Various configurations are possible and contemplated without departing from the scope of the present disclosure.

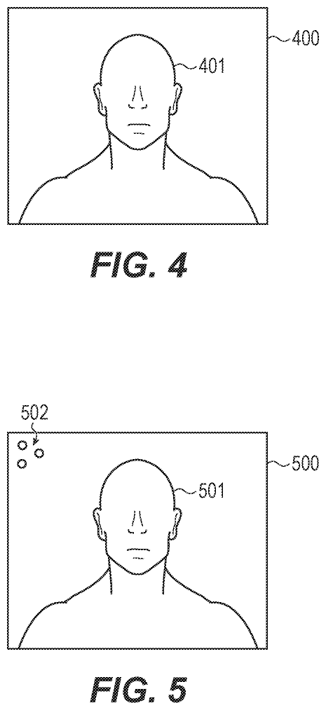

FIG. 4 depicts a first image 400 of a biometric 401. In this example, the biometric 401 corresponds to an upper portion of a person including a face. FIG. 5 depicts a second image 500 of a biometric 501 including a watermark 502. In this example, the biometric 501 also corresponds to an upper portion of a person including a face. As shown, the watermark 502 may include a number of dots.

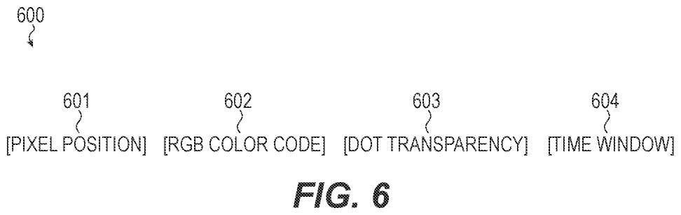

FIG. 6 depicts an example of a time generated code data structure 600. Such a time generated code data structure 600 may be used to store records of and/or provide one or more time generated codes. The time generated code data structure 600 may include information regarding characteristics of one or more watermarks that may be generated and/or applied to one or more images of one or more biometrics.

As shown, the time generated code data structure 600 may include a [pixel position] 601, a [RGB color code] 602, a [dot transparency] 603, and/or a [time window] 604. However, it is understood that this is an example. In some examples, the time generated code data structure 600 may be associated with a time window instead of itself including the [time window] 604. Various configurations are possible and contemplated without departing from the scope of the present disclosure.

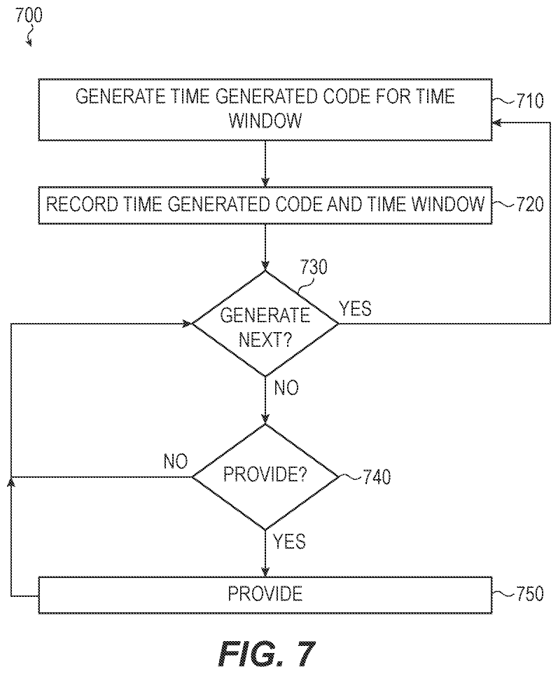

FIG. 7 is a flow chart illustrating a third example method 700 for biometric image liveness detection. The method 700 may be performed by the system 100 of FIG. 1.

At operation 710, an electronic device (such as the server 102) may generate one or more time generated codes for a time window. The time generated code may be a series of time generated codes corresponding to a series of time windows. The time generated code may include information specifying characteristics for a watermark to apply to one or more images of one or more biometrics.

At operation 720, the electronic device may record the time generated code and the time window. For example, the electronic device may store the time generated code and an indicator of the time window that is associated with the time generated code.

At operation 730, the electronic device may determine whether or not to generate a next time generated code. The electronic device may determine to generate a next time generated code when the time window for the previous time generated code has elapsed. Alternatively, the electronic device may generate time generated codes for a number of subsequent time windows at a time, such as 10-15. If so, the flow may return to operation 710 where the electronic device may generate one or more time generated codes for a time window. Otherwise, the flow may proceed to operation 740.

At operation 740, the electronic device may determine whether or not to provide one or more time generated codes. The electronic device may determine to do so in response to a request, upon expiration of a time window, and/or various other factors. If not, the flow may return to operation 730 where the electronic device may again determine whether or not to generate a next time generated code. Otherwise, the flow may proceed to operation 750.

At operation 750, the electronic device may provide the one or more time generated codes. The flow may the return to operation 730 where the electronic device may again determine whether or not to generate a next time generated code.

In various examples, this example method 700 may be implemented using a group of interrelated software modules or components that perform various functions discussed herein. These software modules or components may be executed within a cloud network and/or by one or more computing devices, such as the server 102 of FIG. 1.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 illustrates and describes the same electronic device generating, recording, and providing time generated codes. However, it is understood that this is an example. In various implementations, multiple electronic devices may perform one or more of these operations. Various configurations are possible and contemplated without departing from the scope of the present disclosure.

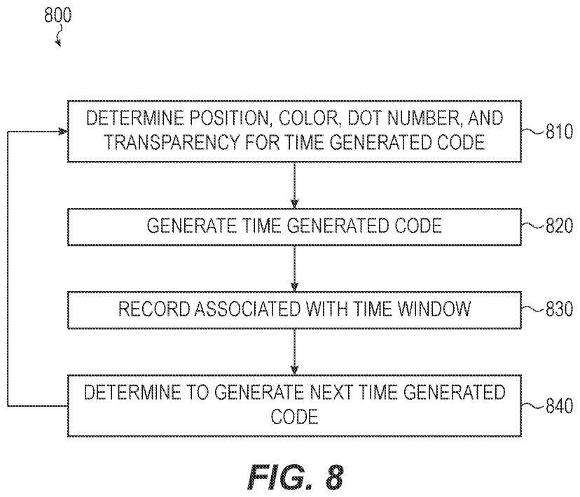

FIG. 8 is a flow chart illustrating a fourth example method 800 for biometric image liveness detection. The method 800 may be performed by the system 100 of FIG. 1.

At operation 810, an electronic device (such as the server 102) may determine a position, color, dot number, and transparency (such the transparency for one or more dots) for a time generated code. At operation 820, the electronic device may generate the time generated code using these characteristics.

These time generated codes generated using these characteristics may be used to generate a watermark that may be applied to one more images of one or more biometrics. One or more of these characteristics may be different from that of a previous time generated code such that the watermark changes position, color, transparency, and so on between images with watermarks generated from different time generated codes applied.

At operation 830, the electronic device may record the time generated code associated with a time window. The time window may be 2 seconds, 10 minutes, and so on. In some examples, the time window may be fixed. In other examples, the time window may be changeable, such as implementations where the time window is shortened in response to detection of spoofing attempts to make spoofing more difficult.

At operation 840, the electronic device may determine to generate a next time generated code. The flow may then return to operation 810 where the electronic device may determine another position, color, dot number, and transparency (such as the transparency for one or more dots) for another time generated code.

In various examples, this example method 800 may be implemented using a group of interrelated software modules or components that perform various functions discussed herein. These software modules or components may be executed within a cloud network and/or by one or more computing devices, such as the of FIG. 1.

Although the example method 800 is illustrated and described as including particular operations performed in a particular order, it is understood that this is an example. In various implementations, various orders of the same, similar, and/or different operations may be performed without departing from the scope of the present disclosure.

For example, the method 800 is illustrated and described as determining position, color, dot number, and transparency. However, it is understood that this is an example. In various implementations, other combinations of the same, similar, and/or different characteristics may be used. Various configurations are possible and contemplated without departing from the scope of the present disclosure.

In various implementations, a system for biometric image liveness detection may include a server and a user device that includes an image sensor. The server may generate a series of time generated codes and record the series of time generated codes and time windows associated with the series of time generated codes. The user device may receive the series of time generated codes; capture a first image of a biometric using the image sensor, the first image overlaid via filter with a watermark corresponding to one of the series of time generated codes whose associated time window corresponds to a current time; capture a second image of the biometric using the image sensor within a time period of the first image; and provide the first image and the second image to the server. The server may determine that the first image and the second image were live captured upon determining that the watermark corresponds to the associated time window.

In some examples, the series of time generated codes may specify a position of at least part of the watermark in the first image, a color of the at least part of the watermark in the first image, or a transparency of the at least part of the watermark in the first image. In a number of such examples, at least one of the position, the color, a number of dots, or the transparency may change between time generated codes of the series of time generated codes. In various such examples, the position may be specified as a pixel position. In some such examples, the color may be specified as an RGB color code.

In a number of examples, the time windows may be between 2 seconds and 10 minutes. In various examples, the time period may be less than 100 microseconds.

In some implementations, a user device may include an image sensor, a non-transitory storage medium that stores instructions, and a processor. The processor may execute the instructions to receive a series of time generated codes from a server, the series of time generated codes associated with time windows; capture a first image of a biometric using the image sensor, the first image overlaid via filter with a watermark corresponding to one of the series of time generated codes whose associated time window corresponds to a current time; capture a second image of the biometric using the image sensor within a time period of the first image; and provide the first image to the server.

In various examples, the series of time generated codes may be unique to the user device and a user associated with the biometric. In some examples, the watermark may include a number of dots. In a number of such examples, the series of time generated codes may specify a first number of dots in the watermark that are fully transparent and a second number of dots in the watermark that are partially transparent. In various such examples, at least one of the first number of dots or the second number of dots may change between time generated codes of the series of time generated codes.

In some examples, the series of time generated codes may be received by an application implemented by the processor and the application may isolate the series of time generated codes from other applications implemented by the processor. In various examples, the biometric may include an image of at least a face of a person.

In a number of implementations, a server may include a non-transitory storage medium that stores instructions and a processor. The processor may execute the instructions to generate a series of time generated codes; record the series of time generated codes and time windows associated with the series of time generated codes; provide the series of time generated codes to a user device that includes an image sensor; receive a first image of a biometric and a second image of the biometric from the user device, the first image captured by the user device using the image sensor, the first image overlaid via filter with a watermark corresponding to one of the series of time generated codes whose associated time window corresponds to a current time, the second image captured by the user device using the image sensor within a time period of the first image; and determine that the first image and the second image were live captured upon determining that the watermark corresponds to the associated time window.

In various examples, the processor may verify that the first image and the second image are unlikely to have been modified, tampered with, or physically faked prior to determining that the first image and the second image were live captured. In some such examples, the processor may verify that the first image and the second image are unlikely to have been modified, tampered with, or physically faked using machine learning pixel detection.

In a number of examples, the processor may compare the biometric in the first image to the biometric in the second image prior to determining that the first image and the second image were live captured. In various examples, the processor may use the second image for biometric identification upon determining that the first image and the second image were live captured. In some examples, the processor may use the second image for biometric identification system enrollment upon determining that the first image and the second image were live captured.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to biometric liveness detection. A series of time generated codes may be tracked by one or more servers. For example, the biometric may correspond to a face of a person. One or more user devices may overlay a watermark on a captured image of a biometric according to one or more of the time generated codes. The one or more servers may detect whether or not the biometric is live by determining whether or not a provided image includes a watermark corresponding to the time generated code for the respective time that the provided image is provided.

The present disclosure recognizes that biometric and/or other personal data is owned by the person from whom such biometric and/or other personal data is derived. This data can be used to the benefit of those people. For example, biometric data may be used to conveniently and reliably identify and/or authenticate the identity of people, access securely stored financial and/or other information associated with the biometric data, and so on. This may allow people to avoid repeatedly providing physical identification and/or other information.

The present disclosure further recognizes that the entities who collect, analyze, store, and/or otherwise use such biometric and/or other personal data should comply with well-established privacy policies and/or privacy practices. Particularly, such entities should implement and consistently use privacy policies and practices that are generally recognized as meeting or exceeding industry or governmental requirements for maintaining security and privately maintaining biometric and/or other personal data, including the use of encryption and security methods that meets or exceeds industry or government standards. For example, biometric and/or other personal data should be collected for legitimate and reasonable uses and not shared or sold outside of those legitimate uses. Further, such collection should occur only after receiving the informed consent. Additionally, such entities should take any needed steps for safeguarding and securing access to such biometric and/or other personal data and ensuring that others with access to the biometric and/or other personal data adhere to the same privacy policies and practices. Further, such entities should certify their adherence to widely accepted privacy policies and practices by subjecting themselves to appropriate third party evaluation.

Additionally, the present disclosure recognizes that people may block the use of, storage of, and/or access to biometric and/or other personal data. Entities who typically collect, analyze, store, and/or otherwise use such biometric and/or other personal data should implement and consistently prevent any collection, analysis, storage, and/or other use of any biometric and/or other personal data blocked by the person from whom such biometric and/or other personal data is derived.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system for biometric image liveness detection, comprising:
a server that:
generates a series of time generated codes; and
records the series of time generated codes and time windows associated with the series of time generated codes; and
a user device that includes an image sensor and:
receives the series of time generated codes;
captures a first image of a biometric using the image sensor, the first image overlaid via filter with a watermark corresponding to one of the series of time generated codes whose associated time window corresponds to a current time;
captures a second image of the biometric using the image sensor within a time period of the first image; and
provides the first image and the second image to the server;
wherein the server determines that the first image and the second image were live captured upon determining that the watermark corresponds to the associated time window.

2. The system of claim 1, wherein the series of time generated codes specify a position of at least part of the watermark in the first image, a color of the at least part of the watermark in the first image, or a transparency of the at least part of the watermark in the first image.

3. The system of claim 2, wherein at least one of the position, the color, a number of dots, or the transparency changes between time generated codes of the series of time generated codes.

4. The system of claim 3, wherein the position is specified as a pixel position.

5. The system of claim 3, wherein the color is specified as an RGB color code.

6. The system of claim 1, wherein the time windows are between 2 seconds and 10 minutes.

7. The system of claim 1, wherein the time period is less than 100 microseconds.

8. A user device, comprising:
an image sensor;
a non-transitory storage medium that stores instructions; and
a processor that executes the instructions to:
receive a series of time generated codes from a server, the series of time generated codes associated with time windows;
capture a first image of a biometric using the image sensor, the first image overlaid via filter with a watermark corresponding to one of the series of time generated codes whose associated time window corresponds to a current time;
capture a second image of the biometric using the image sensor within a time period of the first image; and
provide the first image to the server.

9. The user device of claim 8, wherein the series of time generated codes are unique to the user device and a user associated with the biometric.

10. The user device of claim 8, wherein the watermark comprises a number of dots.

11. The user device of claim 9, wherein the series of time generated codes specify a first number of dots in the watermark that are fully transparent and a second number of dots in the watermark that are partially transparent.

12. The user device of claim 11, wherein at least one of the first number of dots or the second number of dots changes between time generated codes of the series of time generated codes.

13. The user device of claim 8, wherein:
the series of time generated codes are received by an application implemented by the processor; and
the application isolates the series of time generated codes from other applications implemented by the processor.

14. The user device of claim 8, wherein the biometric comprises an image of at least a face of a person.

15. A server, comprising:
a non-transitory storage medium that stores instructions; and
a processor that executes the instructions to:
generate a series of time generated codes;
record the series of time generated codes and time windows associated with the series of time generated codes;
provide the series of time generated codes to a user device that includes an image sensor;
receive a first image of a biometric and a second image of the biometric from the user device, the first image captured by the user device using the image sensor, the first image overlaid via filter with a watermark corresponding to one of the series of time generated codes whose associated time window corresponds to a current time, the second image captured by the user device using the image sensor within a time period of the first image; and
determine that the first image and the second image were live captured upon determining that the watermark corresponds to the associated time window.

16. The server of claim 15, wherein the processor verifies that the first image and the second image are unlikely to have been modified, tampered with, or physically faked prior to determining that the first image and the second image were live captured.

17. The server of claim 16, wherein the processor verifies that the first image and the second image are unlikely to have been modified, tampered with, or physically faked using machine learning pixel detection.

18. The server of claim 15, wherein the processor compares the biometric in the first image to the biometric in the second image prior to determining that the first image and the second image were live captured.

19. The server of claim 15, wherein the processor uses the second image for biometric identification upon determining that the first image and the second image were live captured.

20. The server of claim 15, wherein the processor uses the second image for biometric identification system enrollment upon determining that the first image and the second image were live captured.
